(19) United States
(12) Patent Application Publication
(10) Pub. No.: US 2024/0273733 A1
(43) Pub. Date: Aug. 15, 2024

(54) MULTIPLE CAMERA AND MULTIPLE THREE-DIMENSIONAL OBJECT TRACKING ON THE MOVE FOR AUTONOMOUS VEHICLES

(71) Applicant: BOARD OF TRUSTEES OF THE UNIVERSITY OF ARKANSAS, Little Rock, AR (US)

(72) Inventors: Anh Pha Nguyen, Fayetteville, AR (US); Khoa Luu, Technology, AR (US)

(73) Assignee: BOARD OF TRUSTEES OF THE UNIVERSITY OF ARKANSAS, Little Roack, AR (US)

(21) Appl. No.: 18/438,449

(22) Filed: Feb. 10, 2024

Related U.S. Application Data
(60) Provisional application No. 63/444,971, filed on Feb. 12, 2023.

(51) Int. Cl. G06T 7/20; G06V 10/44; G06V 10/74

(52) U.S. Cl. CPC G06T 7/20; G06V 10/44; G06V 10/761; G06V 2201/07

(57) ABSTRACT

Systems and methods for three-dimensional object tracking across cameras are disclosed. The method includes receiving detection outcomes generated by a three-dimensional object detector from a plurality of synchronized camera inputs, responsive to the receiving, maintaining a graph having nodes and weighted edges between at least a portion of the nodes, executing appearance modeling of the nodes via a self-attention layer of a graph transformer network, and executing motion modeling of the nodes.

### CROSS-REFERENCE TO RELATED APPLICATIONS

This application claims priority to U.S. Provisional Patent Application No. 63/444,971, filed on Feb. 12, 2023. The entirety of the aforementioned application is incorporated herein by reference.

### STATEMENT REGARDING FEDERALLY SPONSORED RESEARCH

This invention was made with government support under 1946391 and OIA-1920920 awarded by the National Science Foundation. The government has certain rights in the invention.

### BACKGROUND

Having enormous data as in recent public datasets helps to improve deep learning-based three-dimensional (3D) object detection. However, it also poses more challenging problems in practice, such as maintaining high accuracy and consistent results in various points of view and environments.

### SUMMARY

In an embodiment, the present disclosure relates to a method of three-dimensional object tracking across cameras. The method includes receiving detection outcomes generated by a three-dimensional object detector from a plurality of synchronized camera inputs, responsive to the receiving, maintaining a graph having nodes and weighted edges between at least a portion of the nodes, executing appearance modeling of the nodes via a self-attention layer of a graph transformer network, and executing motion modeling of the nodes.

In an additional embodiment, the present disclosure relates to a system for three-dimensional object tracking across cameras. The system has memory and at least one processor coupled to the memory and configured to implement a method. The method includes receiving detection outcomes generated by a three-dimensional object detector from a plurality of synchronized camera inputs, responsive to the receiving, maintaining a graph having nodes and weighted edges between at least a portion of the nodes, executing appearance modeling of the nodes via a self-attention layer of a graph transformer network, and executing motion modeling of the nodes.

In a further embodiment, the present disclosure is related to a computer program product having a non-transitory computer-usable medium including computer-readable program code embodied therein. The computer-readable program code is adapted to be executed to implement a method for three-dimensional object tracking across cameras. The method includes receiving detection outcomes generated by a three-dimensional object detector from a plurality of synchronized camera inputs and responsive to the receiving, maintaining a graph comprising nodes and weighted edges between at least a portion of the nodes. The nodes represent tracked objects and comprise appearance features and motion features and the weighted edges are computed based on node similarity. The method further includes executing appearance modeling of the nodes via a self-attention layer of a graph transformer network. The appearance modeling yields resultant appearance-modeling data. The method also includes executing motion modeling of the nodes using the resultant appearance-modeling data via a cross-attention layer of the graph transformer network. The motion modeling yields resultant motion-modeling data.

### BRIEF DESCRIPTION OF THE DRAWINGS

A better understanding of the present invention can be obtained when the following detailed description is considered in conjunction with the following drawings, in which:

FIGS. 1A and 1B illustrate a method (FIG. 1A) and a computing device (FIG. 1B) for three-dimensional object tracking across cameras.

FIG. 2 illustrates that the object detector and tracking method Deep Embedded Feature Tracking (DEFT) fails to detect partial objects in one camera but can detect in another camera (top). The detector fails to detect objects in both cameras (bottom). Arrows indicate true positive detection sample and false negative detection samples.

FIG. 3 illustrates a framework via Graph Transformer Networks, according to aspects of the disclosure.

FIG. 4 illustrates that the method of the present disclosure (top) can recognize a positive tracking case compared with a Multi-Camera Multiple Object Tracking (MC-MOT) system which has no object correlation linking module (i.e., DEFT), for all cameras (bottom). Arrows indicate true positive tracking samples and false negative tracking samples.

FIG. 5 illustrates that the method of the present disclosure (top) can recover a false negative detection case compared with a MC-MOT system which runs independently on each camera (i.e., DEFT) (bottom). Arrows indicate true positive detection samples and false negative detection samples.

### DETAILED DESCRIPTION

It is to be understood that both the foregoing general description and the following detailed description are illustrative and explanatory, and are not restrictive of the subject matter, as claimed. In this application, the use of the singular includes the plural, the word a or an means at least one, and the use of or means and/or, unless specifically stated otherwise. Furthermore, the use of the term including, as well as other forms, such as includes and included, is not limiting. Also, terms such as element or component encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The development of autonomous vehicles provides an opportunity to have a complete set of camera sensors capturing the environment around the car. Object detection and tracking have become important tasks in autonomous vehicles. The recent development of deep learning methods has dramatically boosted the performance of object understanding and tracking in autonomous driving applications thanks to the availability of public datasets. Having enormous data as in recent public datasets helps to improve deep learning-based three-dimensional (3D) object detection. However, it also poses more challenging problems in practice, such as maintaining high accuracy and consistent results in various points of view and environments. The proposed artificial intelligence system directly solves this problem by modeling not only object motion but also the appearance of each tracked object in a 360° view.

Since the development of autonomous vehicles provides an opportunity to have a complete set of camera sensors capturing the environment around the car, it is important for object detection and tracking to address new challenges, such as achieving consistent results across views of cameras. To address these challenges, the present disclosure presents an example solution for a set of tracked objects, called tracklets. The present disclosure describes a new approach to predict existing tracklets location and link detections with tracklets via cross-attention motion modeling and appearance re-identification. This approach aims to solve issues caused by inconsistent 3D object detection. Moreover, this model achieves improvement in the detection accuracy of a standard 3D object detector, for example, in a nuScenes detection challenge. The experimental results on the nuScenes dataset demonstrate the benefits of the proposed method to produce state-of-the-art performance on the existing vision-based tracking dataset.

Various embodiments described herein utilize artificial intelligence to track objects across multiple cameras. The cameras can cover 360° views of autonomous vehicles and are able to maintain accurate object tracking and identification on the move.

The present disclosure describes examples of a new Multiple Camera Multiple Object Tracking framework where a global graph is constructed with nodes containing both appearance and motion features of the tracked objects and weighted edges between tracked objects or nodes. The edge weights are computed based on the similarity in appearance and location between two tracked objects or nodes. Secondly, a new Auto-regressive Graph Transformer network is proposed, including a self-attention layer to transform appearance features and cross-attention to predict the motion features of objects. This network can help to obtain a more robust node embedding to maintain accurate tracking when objects are on side views of cameras. Then, further post-processing of the prediction results with motion propagation and node merging modules are conducted. Finally, the proposed framework is evaluated with a comprehensive evaluation criterion to demonstrate its robustness compared against previous Multiple Camera Multiple Object Tracking frameworks. The proposed method even helps to improve the detection accuracy of a standard 3D object detector on the nuScenes benchmark.

In this approach, a single graph is constructed and maintained across time by graph transformer networks. At a particular time step, the Multiple Camera Multiple Object Tracking framework receives detection outcomes generated by a 3D object detector from all synchronized camera inputs. The detected object contains its location in 3D and its appearance features. Then, the Multiple Camera Multiple Object Tracking framework will update and maintain a set of tracked objects, called tracklets, based on detected objects at a particular time step and its tracklets at the previous time step. Each tracklet's representation is a vector with 3D location and features of the corresponding tracked object. This set of tracklets is represented by a global graph, where the vertex set contains all the tracklets tracked up to that time and the edge set contains the geometry distance between two tracklets. Each node in the graph contains the object's 3D location and its feature embedding, i.e., Re-Identification features. Pre-computed camera and location encoding are used to concatenate with the node features before the first layer. Then, the self-attention layer provides the output embeddings and this output can be used as the input for the next layer if there is more than one self-attention layer. Next, a transformer layer performs a cross-attention mechanism where queries are different from keys. The input of this layer is the output node embedding from previous self-attention layers and the output of this layer are new tracklet nodes for the current frame. It takes an object feature from previous frames as an input query instead. This inherited object feature conveys the appearance and location information of previously seen objects, so this layer could well locate the position of the corresponding object on the current frame and output tracking boxes. This design helps to capture the attention of current frame detection features and previous frame track queries, and to continuously update the representation of object identity and location in each track query embedding.

In various embodiments, the systems and methods described herein can achieve various advantages such as, for example, a new global association graph model to solve the Multiple Camera Multiple Object Tracking problem for Autonomous Vehicles. The proposed framework can learn to perform tracking frame-by-frame in an end-to-end manner starting from detections to motion prediction and global association tracklets with detections. These tasks are enhanced with self-attention and cross-attention layers so that the proposed graph can capture both structural and motion across cameras. Further, the systems and methods described herein can allow for allows for tracking across cameras, improves modeling of object motion, enables appearance of each tracked object in a 360° view, and achieves high accuracy and consistent results for deep learning 3D object detection. In various embodiments, the principles described in the present disclosure are applicable to multiple fields such as, for example, object detection and tracking for autonomous vehicles and object detection and tracking for behavioral animal studies.

### Object Tracking

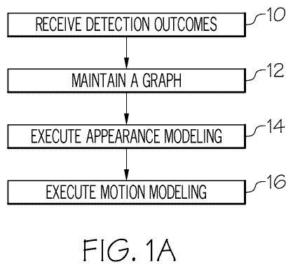

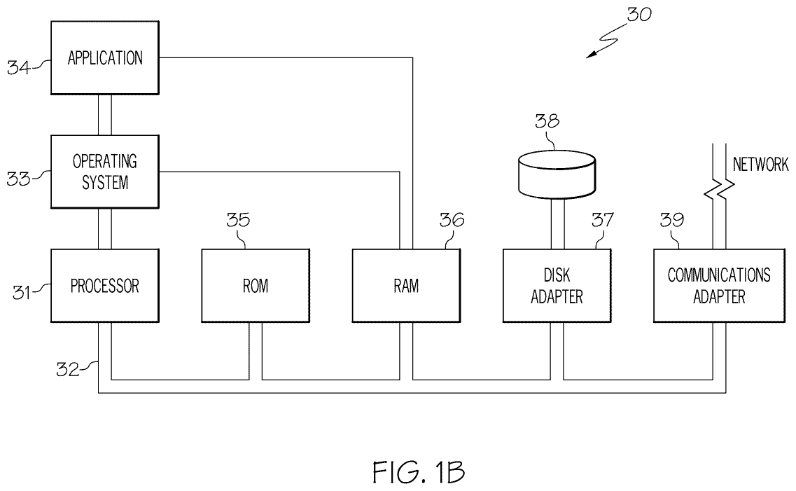

Various methods may be utilized for object tracking. For example, in certain embodiments, the object tracking may include tracking objects with multiple cameras. In some embodiments, the object tracking may be done in three dimensions. As an illustrative example, FIG. 1A shows a method for three-dimensional object tracking across cameras, according to aspects of the disclosure.

At step 10, detection outcomes are received. In certain embodiments, the detection outcomes may be generated by a three-dimensional object detector. In some embodiments, the three-dimensional object detector generates the detection outcomes from, for example, a plurality of synchronized camera inputs.

At step 12, a graph is maintained from the detection outcomes. In some embodiments, the graph may contain nodes. In certain embodiments, the graph may contain weighted edges, for example, between at least a portion of the nodes. In some embodiments, the nodes represent tracked objects. In some embodiments, the tracked objects include at least one of appearance features or motion features. In some embodiments, the tracked object may be a vehicle.

In certain embodiments, the weighted edges are computed based at least in part on node similarity. In some embodiments, the node similarity is computed based on at least one of appearance similarity or location similarity between the tracked objects. In some embodiments, the nodes correspond to an object and/or part of an object.

In some embodiments, the tracked objects are tracklets. In certain embodiments, the tracklets may be based on detected objects at a particular time step and its tracklets at a previous time step. In some embodiments, each tracklet may represent a vector with a three-dimensional location. In certain embodiments, the tracklet may represent features of the corresponding tracked object. In some embodiments, a set of tracklets may be represented by a global graph. In certain embodiments, a vertex set within the global graph may contain all the tracklets tracked up to that time. In such embodiments, the weighted edges contains a geometrical distance between two tracklets. In some embodiments, each node in the graph may contain an object's three-dimensional location and its feature embedding (e.g., re-identification features).

At step 14, appearance modeling is executed. In certain embodiments, the appearance modeling includes, for example, modeling of the nodes via a self-attention layer of a graph transformer network. In some embodiments, the appearance modeling yields resultant appearance-modeling data. In certain embodiments, the self-attention layer provides the output embeddings such that the output can be used as the input for the next layer if, for example, there is more than one self-attention layer.

At step 16, motion modeling of the nodes is executed. In some embodiments, executing the motion modeling of the node may use the resultant appearance-modeling data via a cross-attention layer of the graph transformer network. In certain embodiments, the motion modeling yields resultant motion-modeling data.

In some embodiments, a transformer layer performs the cross-attention mechanism where queries are different. In such embodiments, the input of this layer is the output node embedding from previous self-attention layers and the output of this layer are new tracklet nodes for the current frame. In some embodiments, an inherited object feature conveys the appearance and location information of previously seen objects. A such, this layer can locate the position of the corresponding object on the current frame and output tracking boxes.

In some embodiments, the method may also include a step of post-processing. For example, the resultant motion-modeling data may be post-processed via motion propagation and node merging. In certain embodiments, the post-processing includes adding a node to the graph via link prediction. In some embodiments, the post-processing includes removing a node from the graph via link prediction.

### Computing Devices

The computing devices of the present disclosure can have various architectures. For instance, embodiments of the present disclosure as discussed herein may be implemented using a computing device 30 illustrated in FIG. 1B. Computing device 30 represents a hardware environment for practicing various embodiments of the present disclosure.

Computing device 30 has a processor 31 connected to various other components by system bus 32. An operating system 33 runs on processor 31 and provides control and coordinates the functions of the various components of FIG. 1B. An application 34 in accordance with the principles of the present disclosure runs in conjunction with operating system 33 and provides calls to operating system 33, where the calls implement the various functions or services to be performed by application 34. Application 34 may include, for example, a program for three-dimensional object tracking across cameras, such as in connection with FIG. 1A.

Referring again to FIG. 1B, read-only memory (ROM) 35 is connected to system bus 32 and includes a basic input/output system (BIOS) that controls certain basic functions of computing device 30. Random access memory (RAM) 36 and disk adapter 37 are also connected to system bus 32. It should be noted that software components including operating system 33 and application 34 may be loaded into RAM 36, which may be computing device's 30 main memory for execution. Disk adapter 37 may be an integrated drive electronics (IDE) adapter that communicates with a disk unit 38 (e.g., a disk drive). It is noted that the program for three-dimensional object tracking across cameras, such as in connection with FIG. 1A, may reside in disk unit 38 or in application 34.

Computing device 30 may further include a communications adapter 39 connected to bus 32. Communications adapter 39 interconnects bus 32 with an outside network (e.g., wide area network) to communicate with other devices.

Aspects of the present disclosure are described herein with reference to flowchart illustrations and/or block diagrams of methods, apparatus (systems), and computing devices according to embodiments of the disclosure. It will be understood that computer-readable program instructions can implement each block of the flowchart illustrations and/or block diagrams, and combinations of blocks in the flowchart illustrations and/or block diagrams.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks. The computer-readable program instructions may also be loaded onto a computer, other programmable data processing apparatus, or other devices to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computing devices according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### ADDITIONAL EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example I. Multi-Camera Multiple 3D Object Tracking on the Move for Autonomous Vehicles

The development of autonomous vehicles provides an opportunity to have a complete set of camera sensors capturing the environment around the car. Thus, it is important for object detection and tracking to address new challenges, such as achieving consistent results across views of cameras. To address these challenges, this work presents a new Global Association Graph Model with Link Prediction approach to predict existing tracklets location and link detections with tracklets via cross-attention motion modeling and appearance re-identification. This approach aims at solving issues caused by inconsistent 3D object detection. Moreover, the model exploits to improve the detection accuracy of a standard 3D object detector in the nuScenes detection challenge. The experimental results on the nuScenes dataset demonstrate the benefits of the proposed method to produce SOTA performance on the existing vision-based tracking dataset.

### 1. INTRODUCTION

Object detection and tracking have become one of the most important tasks in autonomous vehicles (AV). Recent development of deep learning methods has dramatically boosted the performance of object understanding and tracking in autonomous driving applications thanks to the availability of public datasets. Far apart from prior video tracking datasets collected via single or stereo cameras, e.g., the Karlsruhe Institute of Technology and Toyota Technological Institute (KITTI), recent public datasets and their defined tracking problems have become more realistic with multiple cameras in autonomous vehicles. They usually have a full set of camera sensors that aim to create a 360° surround view and provide more redundancy as backup, i.e., more overlapping field-of-views. There are some popular large-scale tracking datasets with multiple sensor setup, such as nuScenes, Waymo, Lyft, or Argoverse. They have a lot more data than KITTI ranging from multiple surrounding cameras, light detection and ranging (LiDAR), radars, and global positioning systems (GPSs).

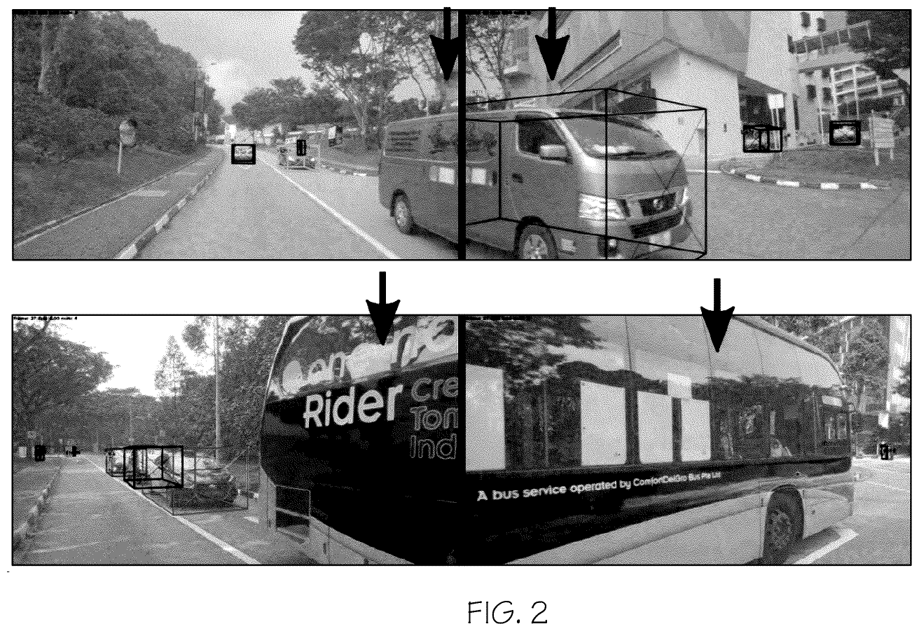

Having enormous data as in recent public datasets helps to improve deep learning-based 3D object detection. However, it also poses more challenging problems in practice, such as maintaining high accuracy and latency performance in variety points of views and environments. In addition, Multiple Object Tracking (MOT) is usually employed together with 3D object detection to track objects and maintain stability of prediction across video frames. To handle multiple views, a common approach to Multi-Camera Multiple Object Tracking (MC-MOT) is to firstly apply an MOT approach on each camera independently, i.e., single camera tracking (SCT), then link local tracklets across cameras together via global matching steps based on Re-ID features. However, this approach creates more errors, i.e., fragmented local tracklets, and more computation since the data association and the matching steps will perform multiple times both locally and globally. Therefore, using SCT multiple times is not the optimal option. In addition, it is unable to handle scenarios when the detector fails to detect objects from one of the cameras as shown in FIG. 2.

Therefore, this Example proposes to formulate MC-MOT problem as a global association graph in a 360 degree view using an object detection as the inputs instead of SCT trajectories. Applicants proposed MC-MOT approach not only models object motion but also the appearance of each tracked object. Applicants encode both location and appearance features in the node embeddings of the proposed graph where the nodes corresponding to each tracked object are updated and added to the graph over time. In addition, Applicants adopt the new self-attention and cross-attention layers to decode motion and location, then propagate them across camera systems via 3D-to-2D transformation.

Contributions of this Example: The main contributions of this Example can be summarized as follows. A new MC-MOT framework is firstly introduced where a global graph is constructed with nodes containing both appearance and motion features of the tracked objects and the weighted edges between tracked objects or nodes. The edge weights are computed based on the similarity in appearance and location between two tracked objects or nodes. Secondly, Applicants present a new Auto-regressive Graph Transformer network including a self-attention layer to transform appearance features and cross-attention to predict the motion features of objects. This network can help to obtain a more robust node embedding to maintain accurate tracking when objects are on side views of cameras. Then, Applicants further post-process the prediction results with motion propagation and node merging modules. Finally, the proposed framework will be evaluated with a comprehensive evaluation criterion to demonstrate its robustness compared against previous MC-MOT frameworks. The proposed method even helps to improve the detection accuracy of a standard 3D object detector on the nuScenes benchmark.

### 2. RELATED WORK

MOT problem on AVs has recently received a lot of attention from the research community. There is an increasing amount of research work targeting trajectory estimation on moving sensors or combining appearance information to determine object IDs.

Tracking using Motion Model: One proposal is a simple yet effective baseline that utilizes classic state estimator Kalman Filter for 3D bounding boxes. It can be obtained not only from a LiDAR point cloud object detector but also from an image-based object detector. It improves the Kalman Filter tracking system by measuring the Mahalanobis distance between the predicted states and observations. This method is promisingly reliable in filtering outliers and handling both partially and fully occluded objects.

Tracking using Appearance Model: Some approaches are widely used in single camera tracking problems. For example, by treating objects as points, these approaches simplify the tracking procedure that is usually a combination of many expensive steps from detection to assigning object ID. They introduce a novel disentangling transformation for detection loss and a self-supervised term for bounding boxes confidence score. They try to estimate robust 3D box information from 2D images then adopt 3D box-reordering and LSTM as a motion module to link objects across frames.

Tracking using Hybrid Approaches: Another approach is to train the object detection and the object association task simultaneously by adding a feature extractor and a matching head after object detector. Besides, an LSTM is used as a motion prediction module as an alternative to other approaches. Similarly, another approach is to follow the same process, but perform feature extraction on point cloud maps.

Tracking using Modern Approaches: Graph Neural Network, Self-Attention, and Transformer introduce a new learning-from-context paradigm. It recently has attracted considerable attention from the research community because of its promising performance in a wide range from Natural Language Processing to Computer Vision tasks. Currently, there are none of these methods applied in MC-MOT on autonomous vehicles but it is worthy to name a few SCT-MOT approaches. The first feature interaction method that leverages Graph Neural Network has been proposed to individually adapt an object feature to another object features. Additionally, a new tracking-by-attention paradigm besides existing tracking-by-regression, tracking-by-detection and tracking-by-segmentation to deal with occlusions and reason out tracker's spatio-temporal correspondences has also been proposed. Moreover, a Query-Key mechanism has been utilized to perform joint-detection-and-tracking, disentangle complex components in previous tracking systems.

### 3. PROPOSED METHOD

In this section, Applicants first overview the proposed 3D object tracking pipeline where Applicants construct and a maintain Global Graph with the Graph Transformer Networks in 3.1. Then, Subsection 3.2 will detail the structure of Graph Transformer Networks and how it is used to model appearance and motion of tracked objects. Finally, 3.4 describes how Applicants train the Graph Transformer Networks.

### 3.1. MC-MOT via Global Graph Constructing

Given C cameras, denoted by the set [symbol] ={c₁, . . . , c_{C}}, they are used to perceive surrounding environment of a vehicle. In MC-MOT, Applicants assume each camera attached with an off-the-shelf 3D object detector to provide initial location of objects in real-world coordinates. In this work, KM3D is used to provide 3D object location and features but it can be replaced by any other 3D object detectors.

In the previous MC-MOT approaches, the methods depend on tracking results of an MOT algorithm on each camera independently. There is no mechanism to model the relationship between cameras while they have a strong relation. Instead, Applicants proposed MC-MOT take detection results directly from the detectors and match with current tracked objects using an auto-regressive approach by taking the cameras relation into consideration. In this approach, a single graph is constructed and maintained across time by graph transformer networks (detailed in Sec. 3.2).

At time step t, the MC-MOT framework receives detection outcomes [symbol] _{c}^{(t)}={o_{i,c}^{(t)}} generated by a 3D object detector from all synchronized camera inputs. The detected i-th object o_{i,c}^{(t)} contains its location in 3D l_{i,c}^{(t)} and its features f_{i,c}^{(t)}. Then, the MC-MOT framework will update and maintain a set of tracked objects, called tracklets [symbol] _{c}^{(t)}={tr_{k,c}^{(t)}}, based on detected objects at time step t and previous tracklets at time step t−1. Each tr_{k,c}^{(t)} is a vector with 3D location and features of the corresponding tracked object. This set of tracklets are represented by a global graph [symbol] ^{(t)}=( [symbol] ^{(t)}, ϵ^{(t)}), where the vertex set [symbol] ^{(t)} contains all the tracklets [symbol] _{c}^{(t)} tracked up to time t and the edge set ϵ^{(t)} contains geometry distance between two tracklets. In this way, [symbol] ^{(t)} can be obtained using graph transformer networks from a joint set of [symbol] nodes of the previous graph [symbol] ^{(t-1)} and [symbol] new nodes formed by current detections [symbol] _{c}^{(t)}s. The changes in the global graph from frame-to-frame are likely adding new nodes as new objects are detected or removing old nodes as tracklets are out of view. This step is done by graph link prediction using a Softmax classifier. Next, Applicants will discuss how the transformer decoder can be employed to update the embedding features for each node with self-attention layer and how to predict tracked objects' motion via cross-attention layer.

### 3.2. Auto-Regressive Graph Transformer Networks

In this section, Applicants introduce Graph Transformer Networks (GTN) to transform and update node embeddings by attending to other nodes for robust appearance and motion modeling. First, the building blocks of this GTN, i.e. graph self-attention layer and graph cross-attention layer, are presented in Sub-sec. 3.2.1 and 3.2.2, respectively. Then, Applicants perform motion propagation and node merging operators that include the removing and the adding nodes in the graph via link prediction in Sub-sec. 3.2.3 and 3.2.4, respectively.

### 3.2.1. Graph Self-Attention Layer for Appearance Modeling

Each node k∈ [symbol] ^{(t)} in the graph [symbol] ^{(t)} contains the object's 3D location l_{k,c}^{(t)} and its feature embedding f_{k,c}^{(t)}, i.e., Re-ID features. The Re-ID features are provided by KM3D as its outputs together with 3D box predictions. To consider the effects of cameras on appearance features, the self-attention layer takes the input node features as the concatenation of embedding features with camera and location encoding as hₖ^{l}={f_{k,c}^{(t)}|c|l_{k,c}^{(t)}}∈ [symbol] ^{D}^{_{E}}, where l=0 only applied for the input of the first layer, f_{k,c}^{(t)}∈ [symbol] ^{D}^{_{F}}, c∈ [symbol] ^{D}^{_{C}} and l_{k,c}^{(t)}∈ [symbol] ³. Applicants use pre-computed camera and location encoding to concat with the node features before the first layer, similar to how positional encodings are added in the original Transformer. Then, the self-attention layer provides the output embeddings as hₖ^{l+1} for layer l. This output can be used as the input for the next layer if there is more than one self-attention layer.

In order to further improve pairwise attention scores, Applicants incorporate pairwise edge features by multiplying them together. In summary, the output of the self-attention layer is computed as follows,

$${h}_{k}^{′ l + 1} = {O}_{h}^{l} {∥}_{i = 1}^{H} ( {\sum }_{j ∈ {𝒱}^{( t )}} {w}_{kj}^{i , l} {V}^{i , l} {h}_{k}^{l} ) \qquad ( 1 )$$

$${e}_{kj}^{′ l + 1} = {O}_{e}^{l} {∥}_{i = 1}^{H} ( {\sum }_{j ∈ {𝒱}^{( t )}} {w}_{kj}^{′ i , l} ) \qquad ( 2 )$$

$${w}_{kj}^{i , l} = {softmax}_{j} ( {w}_{kj}^{′ i , l} ) \qquad ( 3 )$$

$${w}_{kj}^{′ i , l} = ( \frac{{Q}^{i , l} {h}_{k}^{l} \cdot {K}^{i , l} {h}_{j}^{l}}{\sqrt{{D}_{h}}} ) \cdot {E}^{i , l} {e}_{kj}^{l} \qquad ( 4 )$$

where wₖⱼ^{i,l} are the attention coefficients for the i-th attention head, ∥ is the feature vector concatenation operation, Q^{i,l}, K^{i,l}, V^{i,l}, E^{i,l}∈ [symbol] ^{D}^{_{Z}}^{×D}^{_{E}} denote the queries, keys, values linear projection matrices and node embedding, respectively, as defined in and D_{Z} is the output feature dimension. H denotes number of attention head in multi-head attention setting.

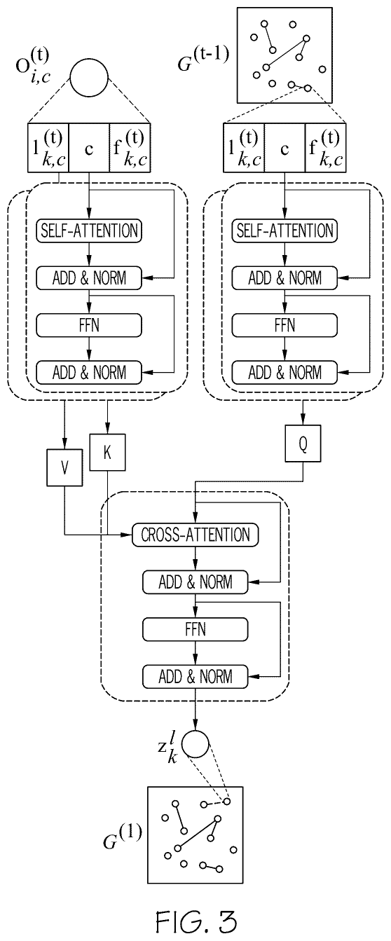

The outputs hₖ^{l+1} and eₖⱼ^{l+1} are then passed through feed forward layers with residual connections and normalization layers (see FIG. 3), defined as follows.

$${h}_{k}^{″ l + 1} = norm ( {h}_{k}^{′ l + 1} + {h}_{k}^{l} ) \qquad ( 5 )$$

$${h}_{k}^{′′′ l + 1} = {FFN}_{h}^{l} ( {h}_{k}^{″ l + 1} ) \qquad ( 6 )$$

$${h}_{k}^{l + 1} = norm ( {h}_{k}^{″ l + 1} + {h}_{k}^{′′′ l + 1} ) \qquad ( 7 )$$

where h″ₖ^{l+1} and h″ₖ^{l+1} denote the outputs of intermediate layers. FFN is the feed forward layers.

$${e}_{kj}^{″ l + 1} = norm ( {e}_{kj}^{′ l + 1} + {e}_{kj}^{l} ) \qquad ( 8 )$$

$${e}_{kj}^{′′′ l + 1} = {FFN}_{e}^{l} ( {e}_{kj}^{″ l + 1} ) \qquad ( 9 )$$

$${e}_{kj}^{l + 1} = norm ( {e}_{kj}^{″ l + 1} + {e}_{kj}^{′′′ l + 1} ) \qquad ( 10 )$$

where e″ₖ^{l+1} and e″ₖ^{l+1} denote the outputs of intermediate layers.

### 3.2.2. Graph Transformer Layer for Motion Modeling

In this section, Applicants demonstrate how tracked objects in tracklet nodes are used as queries while newly detected objects are used as keys and values in the proposed transformer layer. This layer performs a cross-attention mechanism instead of self-attention mechanism where queries are different from keys. The input of this layer is the output node embedding from previous self-attention layers and the output of this layer are new tracklet nodes for the current frame t. It takes an object feature from previous frames as input query instead. This inherited object feature conveys the appearance and location information of previously seen objects, so this layer could well locate the position of the corresponding object on the current frame and output tracking boxes. This design helps to capture the attention on current frame detection features and previous frame track queries, to continuously update the representation of object identity and location in each track query embedding.

Applicants first put together all detected objects as [symbol] ∈ [symbol] and all tracked objects as [symbol] ∈ [symbol] . Then the l-th output of the multi-head cross attention layer is defined as:

$${z}_{k}^{l} = {O}_{z}^{l} {∥}_{i = 1}^{H} ( {\sum }_{j ∈ {X}_{𝒪}} {W}_{kj}^{i , l} {V}^{i , l} {X}_{𝒯}^{T} [ k ] ) \qquad ( 11 )$$

$${W}_{kj}^{i , l} = {softmax}_{j} ( \frac{{Q}^{i , l} {X}_{𝒯}^{T} [ k ] \cdot {K}^{i , l} {X}_{𝒪}^{T} [ j ]}{\sqrt{{D}_{h}}} ) \qquad ( 12 )$$

where Q^{i,l}, K^{i,l}, V^{i,l}∈ [symbol] ^{D}^{_{E}}^{×D}^{_{Z}}, are the queries, keys and values linear projection matrices, respectively, as defined in and D_{Z} is the output feature dimension.

Similar to the attention layer, Applicants can stack multiple cross-attention layers together. Then Applicants get the final output to pass through FFN to provide final set of new node embeddings including location and class predictions for frame t.

### 3.2.3. Cross-Camera Motion Propagation

In this section, Applicants provide a more detailed formulation on how to obtain Re-ID features of the detected objects from camera cₖ to camera cⱼ. First, Applicants compute the transformation matrix to transform 3D object locations to 2D/image coordinates. This transformation which is composed of a transformation from camera-to-world for camera cₖ, a transformation from world-to-camera for camera cⱼ, and a transformation from camera-to-image for camera cⱼ, is defined as follows:

$${M}_{kj} = {M}_{{I}_{j}} * {M}_{{E}_{j}} * {M}_{{E}_{k}}^{- 1} \qquad ( 13 )$$

where M_{E}_{ⱼ} and M_{E}_{ₖ}⁻¹ are the extrinsic camera matrix for camera cₖ to camera cⱼ, respectively. M_{I}_{ⱼ} is the intrinsic camera matrix for camera cⱼ. Note that Applicants only consider two adjacent cameras cₖ and cⱼ where they have a certain amount of overlapping views. Then, Applicants use the transformed 2D/image location to extract the re-id features at the corresponding location on the image. Finally, Applicants update the existing node or add a new node for all the tracked objects tr_{k,c}_{ⱼ}^{(t)}.

### 3.2.4. Node Merging via Edge Scoring

After having transformed node and edge features, Applicants train a fully connected layer and a softmax layer as a classifier to determine the similarity between two nodes. The classifier produces a probability score s∈[0,1]. The higher the score is, the more likely the two nodes are linked. Then Applicants remove detection nodes that have a low-class score which indicates that the detection is matched with an existing tracklet. Applicants also merge nodes that have high similarity scores that have the same camera encoding, i.e., detected within single camera and update edge weights as the similarities among tracklet nodes to indicate the same target ID from different cameras. These steps are similar to a non-maximum suppression (NMS) applied to trajectory for post-processing although a cross-attention layer help spatially discriminate almost identical track query embeddings merging to the same target ID.

### 3.3. Processing Flow

In this section, Applicants briefly summarize the pipeline of the proposed graph transformer networks to predict tracklet motion, motion propagation and node merging in Algorithm 1 in Table 1.

TABLE 1
Description of Algorithm 1.
Algorithm 1 The process pipeline for global graph con-
structing, motion prediction, propagation & node merging

| | |
|---|---|
| 1: | Init t ← 0 /* Time */, V ← ∅ |
| 2: | while t < tₘₐₓ do |
| 3: | Obtain the set of detected objects [symbol] _{c}^{(t)} from 3D ob- |
| | ject detector [ ₁₆ ] in all cameras. |
| 4: | for o_{k,c}^{(t)} ϵ [symbol] _{c}^{(t)} |
| 5: | [symbol] ^{(t)} ← [symbol] ^{(t-1)} ∪ o_{k,c}^{(t)} /* Add new nodes to graph |
| | */ |
| 6: | /* Use the vector {f_{k,c}^{(t)}\|c\|l_{k,c}^{(t)}} as node features. */ |
| 7: | end for |
| 8: | for k ϵ [symbol] ^{(t)} do |
| 9: | Obtain new node embedding h′ₖ /* Section 3.2.1 |
| | */ |
| 10: | end for |
| 11: | Obtain new set of nodes [symbol] ′^{(t)} with location and clas- |
| | sification of tracked objects tr_{k,c}^{(t)} via motion model- |
| | ing /* Section 3.2.2 */ |
| 12: | for c ϵ C do |
| 13: | Propagate the location of tr_{c}^{(t)} to adjacent cameras |
| | /* Section 3.2.3 */ |
| 14: | end for |
| 15: | for vᵢ ϵ [symbol] ′^{(t)} do |
| 16: | Obtain edge scoring to the remaining nodes and |
| | node merging /* Section 3.2.4 */ |
| 17: | Assign ID based on edge scores. |
| 18: | end for |
| 19: | t ← t + 1 |
| 20: | end while |

In this section, Applicants present how to train the proposed graph transformer networks, including self-attention and cross-attention layers.

Training Data: Applicants train the proposed method on a large-scale dataset, i.e., nuScenes, training set with 750 scenes of 20 s each and use its validation set for the ablation study. The ground truth 3D bounding boxes and the extracted ReID features from the pre-trained models in were used together as the inputs for training GTN. Each training sample contains a chunk size of two consecutive frames from a training sequence.

Training Loss: The framework can be trained with two adjacent frames by optimizing for detections and tracklets prediction at frame t, given previous frame tracklets. The joint objective function includes learning node embedding capturing both structural information from the graph, computing weighted linking score between two nodes in the graph and learning to predict tracklets motion.

For learning node embedding, Applicants measure binary cross-entropy loss [symbol] _{emb} between nodes that belong to the same objects for the model to output similar feature embeddings.

$${ℒ}_{emb} ( {v}_{k} ) = {\sum }_{{v}_{j} ∈ {𝒩}_{b}^{( t )} ( {v}_{k} )} - log ( σ ( 〈 {e}_{{v}_{k}}^{′} , {e}_{{v}_{j}}^{′} 〉 ) ) - {w}_{g} {\sum }_{{v}_{i} ∈ {𝒩}_{g}^{( t )} ( {v}_{k} )} log ( 1 - σ ( 〈 {e}_{{v}_{k}}^{′} , {e}_{{v}_{i}}^{′} 〉 ) ) \qquad ( 14 )$$

where <⋅> is the inner production between two vectors, σ is Sigmoid activation function, [symbol] _{b}^{(t)}(vₖ) is the set of fixed-length random walk neighbor nodes of vₖ at time step t, [symbol] _{g}^{(t)}(vₖ) is a negative samples of vᵢ for time step t, [symbol] ₐ^{(t)}(vₖ)= [symbol] _{b}^{(t)}(vₖ)∪ [symbol] _{g}^{(t)}(vₖ) and w_{g}, negative sampling ratio, is an adjustable hyper-parameter to balance the positive and negative samples.

For edge scoring, Applicants use a cross-entropy loss function [symbol] _{c}(eₖⱼ) based on measurement features to ensure the score between two nodes that are connected is higher than other nodes.

For learning to predict tracklets motion, Applicants set prediction loss to measure the set of predictions for [symbol] detections and [symbol] tracklets comparing with ground truth objects in terms of classification and location (bounding boxes). Set-based loss produces an optimal bipartite matching between [symbol] detections and ground truth objects while [symbol] tracklets will be matched with boxes from previous frames. The matching cost is defined as follows.

$${ℒ}_{set} = {\sum }_{i = 1}^{{N}_{𝒪} + {N}_{𝒯}} ( {λ}_{cls} {ℒ}_{cls} + {λ}_{box} {ℒ}_{box} + {λ}_{iou} {ℒ}_{iou} ) \qquad ( 15 )$$

where λ_{cls}, λ_{box} and λᵢₒᵤ are combination weighting parameters for each component losses. [symbol] _{cls} is the cross-entropy loss between prediction classification and ground truth category labels. [symbol] _{box} and [symbol] ᵢₒᵤ are the [symbol] ₁ loss and the generalized intersection over union (IoU) for 3D bounding boxes. Finally, the total loss defined as:

[symbol]

ₜₒₜₐₗ= [symbol] _{emb}+ [symbol] _{c}+ [symbol] ₛₑₜ (16)

### 4. EXPERIMENTAL RESULTS

In this Section, Applicants detail the benchmark dataset and metrics in Subsection 4.1. Then, the setups for all experiments and the ablation study will be presented in Subsections 4.2 and 4.3 respectively. The comparisons with the State-of-the-Art (SOTA) methods will be detailed in Subsection 4.4 on a large-scale Tracking Challenge, i.e., nuScenes Vision Track.

### 4.1. Benchmark Dataset and Metrics

### 4.1.1 Dataset

nuScenes is one of the large-scale datasets for Autonomous Driving with 3D object annotations. It contains 1,000 videos of 20-second shots in a setup of 6 cameras, i.e., 3 front and 3 rear ones, with a total of 1.4M images. It also provides 1.4M manually annotated 3D bounding boxes of 23 object classes based on LiDAR data. This dataset is an official split of 700, 150 and 150 videos for training, validation, and testing, respectively.

### 4.1.2. Metrics

The proposed method is evaluated using both detection and tracking metrics.

Detection Metrics: A commonly used metric, i.e., Mean Average Precision (mAP), is defined as a match using a 2D center distance on the ground plane instead of intersection over union cost for nuScenes detection challenges.

Similarly, other motion-related metrics are also defined in nuScenes, such as Average Translation Error (ATE) measuring Euclidean center distance in 2D in meters, Average Scale Error (ASE) computing as 1—IOU after aligning centers and orientation, Average Orientation Error (AOE) measuring by the smallest yaw angle difference between prediction and ground-truth in radians, Average Velocity Error (AVE) measuring the absolute velocity error in m/s and Average Attribute Error (AAE) computing as 1—acc, where acc is the attribute classification accuracy.

Finally, Applicants also use the nuScenes Detection Score (NDS) that is based on a simple additive weighting of the mean of all other metrics above, including mAP, mATE, mASE, mAOE, mAVE and mAAE.

Tracking Metrics: The tracking performance is measured using the popular CLEAR MOT metrics including MOTA, MOTP, ID switch (IDS), mostly tracked (MT), mostly lost (ML), fragmented (FRAG). Similar to nuScenes, Applicants use two accumulated metrics introduced in as the main metrics, including the average over the MOTA metric (Average MOTA (AMOTA)) and the average over the MOTP metric (Average MOTP (AMOTP)).

### 4.2. Experiments Setup [ssec:exp setup]

The proposed graph transformer networks module is trained with two consecutive frames where the graph { [symbol] ^{(t-1)}} in the previous time step is used to predict new graph [symbol] ^{*t)} at time step t. Then, Mini-batch (chunk of two) gradient descent is employed with Adam optimizer to learn all the parameters in the attention layers.

### 4.3. Ablation Study [ssec:ablation Study]

In this section, Applicants present some experiments to ablate the effect of each component of the proposed framework. Particularly, this section aims to demonstrate the followings: (1) a better motion modeling with cross-attention layer in GTN; and (2) The role of architecture choice of graph transformer networks.

The Role of Motion Model: In this experiment, Applicants evaluate the effectiveness of different motion modeling methods on detection performance. Applicants use the locations predicted by motion models to compare with ground truth locations in terms of motion-related metrics. In such way, Applicants can evaluate how good the motion model capturing and predicting the motion of tracked objects. Applicants compare with two other commonly used motion models, i.e., 3D Kalman Filter and LSTM. As shown in Table 2, the GTN gives better results than a classical object state prediction technique, i.e., 3D Kalman Filter used in and a deep learning-based technique, i.e. LSTM module.

TABLE 2
Motion Errors comparison for different motion modeling.

| Method | mATE ↓ | mASE ↓ | mAOE ↓ | mAVE ↓ |
|---|---|---|---|---|
| 3D KF | 0.8153 | 0.5155 | 0.7382 | 1.6186 |
| LSTM | 0.8041 | 0.4548 | 0.6744 | 1.6139 |
| Disclosure | 0.5132 | 0.4388 | 0.3677 | 1.2189 |

TABLE 3
Ablation study on different configuration for
self-attention and cross-attention layers.

| Structures | mATE ↓ | mASE ↓ | mAOE ↓ | mAVE ↓ |
|---|---|---|---|---|
| Self-attn 1-layer | 0.812 | 0.298 | 0.820 | 1.187 |
| Self-attn 2-layer | 0.785 | 0.286 | 0.703 | 1.284 |
| Self-attn 3-layer | 0.750 | 0.293 | 0.485 | 1.432 |
| Cross-attn 1-layer | 0.824 | 0.293 | 0.866 | 1.281 |
| Cross-attn 2-layer | 0.772 | 0.279 | 0.670 | 1.287 |
| Cross-attn 3-layer | 0.513 | 0.439 | 0.368 | 1.219 |

TABLE 4
Comparison of 3D tracking performance on the nuScenes validation set for Vision Track
challenge. Glo. Assoc. indicates methodlinking object IDs across all cameras.

| | Glo. | | | | | | | | | | |
|---|---|---|---|---|---|---|---|---|---|---|---|
| Method | Assoc. | AMOTA | AMOTP | MOTAR | MOTA ↑ | MOTP ↓ | RECALL ↑ | MT ↑ | ML ↓ | IDS ↓ | FRAG ↓ |
| MonoDIS | X | 0.045 | 1.793 | 0.202 | 0.047 | 0.927 | 0.293 | 395 | 3961 | 6872 | 3229 |
| CenterTrack | X | 0.068 | 1.543 | 0.349 | 0.061 | 0.778 | 0.222 | 524 | 4378 | 2673 | 1882 |
| DEFT | X | 0.213 | 1.532 | 0.49 | 0.183 | 0.805 | 0.4 | 1591 | 2552 | 5560 | 2721 |
| QD-3DT | X | 0.242 | 1.518 | 0.58 | 0.218 | 0.81 | 0.399 | 1600 | 2307 | 5646 | 2592 |
| Disclosure | ✓ | 0.24 | 1.52 | 0.568 | 0.197 | 0.832 | 0.453 | 1643 | 2162 | 1362 | 1462 |

TABLE 5
Comparison of 3D object detectors with and without using motion propagation
(MP) and node merging (NM) modules of the disclosure in terms of detection
metrics on the nuScenes validation set for Vision Detection challenge.

| Method | mAP ↑ | NDS ↑ | mATE ↓ | mASE ↓ | mAOE ↓ | mAVE ↓ | mAAE ↓ |
|---|---|---|---|---|---|---|---|
| MonoDIS | 0.2976 | 0.3685 | 0.7661 | 0.2695 | 0.5839 | 1.3619 | 0.184 |
| MonoDIS + | 0.3019 | 0.3893 | 0.6558 | 0.2410 | 0.6787 | 1.3209 | 0.184 |
| MP + NM | | | | | | | |
| CenterNet | 0.3027 | 0.3262 | 0.7152 | 0.2635 | 0.6158 | 1.4254 | 0.6567 |
| CenterNet + | 0.3487 | 0.4016 | 0.5417 | 0.2023 | 0.6317 | 1.3094 | 0.6567 |
| MP + NM | | | | | | | |
| KM3D | 0.2763 | 0.3201 | 0.7495 | 0.2927 | 0.4851 | 1.4322 | 0.6535 |
| KM3D + | 0.3503 | 0.4117 | 0.6998 | 0.2323 | 0.1861 | 1.8341 | 0.5166 |
| MP + NM | | | | | | | |

The Configuration for Graph Transformer Networks: Applicants conduct additional ablation studies to evaluate the effects on configuration of the attention modules in GTN, including the number of attention layers. Table 3 shows the performance of the proposed framework in terms of detection metrics using various configuration of the attention modules. Applicants change the number of layers for self-attention and the cross-attention layers independently. Applicants use a fixed number of layers, i.e., 2, for self-attention and the cross-attention layers while changing the other, respectively.

### 4.4. Comparison Against The State-of-the-Art Methods

In this section, Applicants first compare the proposed framework with other vision-based (without using LiDAR or RADAR information) tracking approaches, which are the top in nuScenes vision only tracking challenge leaderboard. Then Applicants conduct an experiment to demonstrate that using tracked 3D bounding boxes from the tracking framework can improve the detection metrics.

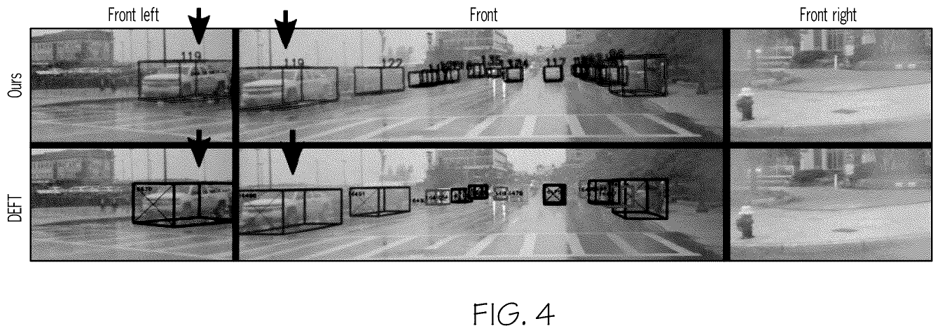

Comparison against Tracking Methods on Tracking Metrics: This experiment compares the proposed method with other vision-based methods, including MonoDIS, CenterTrack and Deep Embedded Feature Tracking (DEFT), QD-3DT which are the top/winner of nuScenes vision only tracking challenge. As can be seen in Table 4, the method decreases error rates compared to top approaches, i.e., DEFT, in most of the metrics. FIG. 4 illustrates the factors that help improve the tracking performance is that Applicants perform appearance matching across cameras in addition to motion modeling. It shows that the proposed method (top) can assign object ID globally between cameras compared with DEFT (bottom).

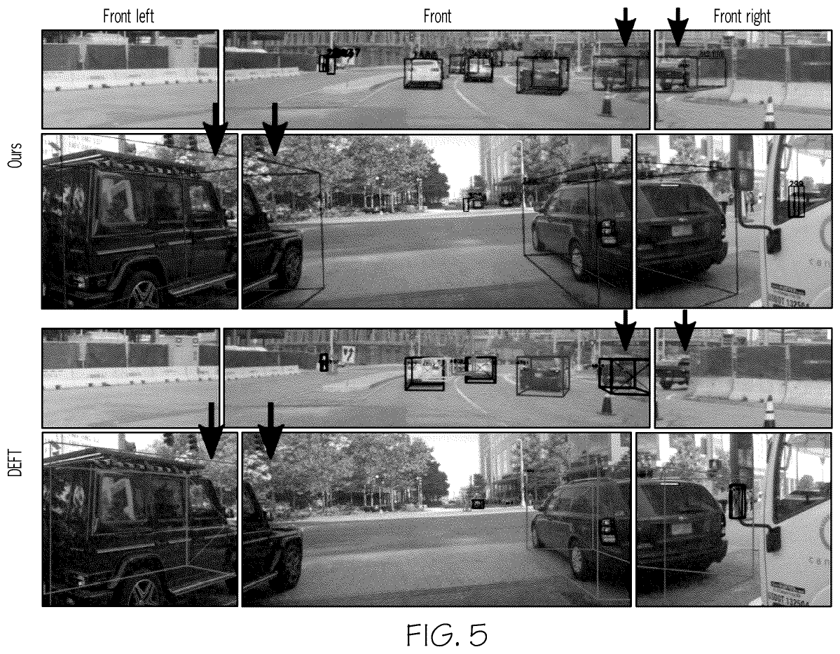

Comparison against Detection Methods on Detection Metrics: Table 5 demonstrates that the combination of object detector and the motion propagation (MP) and node merging (NM) modules achieves the better results than original object detector. In this experiment, Applicants compare three different 3D object detectors, including KM3D, MonoDIS, and CenterNet. The best result achieves with the combination of KM3D object detector and the MP+NM modules since it is guided by global decoded locations from the transformation procedure as described in 3.2.3. FIG. 5 illustrates the improvement on detector fail cases with the help from the tracking framework.

### 5. CONCLUSIONS

This Example has introduced a new global association graph model to solve the MC-MOT problem for AV. The proposed framework can learn to perform tracking frame-by-frame in an end-to-end manner starting from detections to motion prediction and global association tracklets with detections. These tasks are enhanced with self-attention and cross-attention layers so that the proposed graph can capture both structural and motion across cameras. The experiments show performance improvements in a large-scale dataset in AV in terms of vision-based detection and tracking accuracy.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. A method of three-dimensional object tracking across cameras, comprising, by a computer system:
receiving detection outcomes generated by a three-dimensional object detector from a plurality of synchronized camera inputs;
responsive to the receiving, maintaining a graph comprising nodes and weighted edges between at least a portion of the nodes;
executing appearance modeling of the nodes via a self-attention layer of a graph transformer network; and
executing motion modeling of the nodes.

2. The method of claim 1, wherein the nodes represent tracked objects comprising at least one of appearance features or motion features.

3. The method of claim 1, wherein the weighted edges are computed based at least in part on node similarity.

4. The method of claim 3, wherein the node similarity is computed based on at least one of appearance similarity or location similarity between the tracked objects.

5. The method of claim 1, wherein the appearance modeling yields resultant appearance-modeling data.

6. The method of claim 5, wherein the executing the motion modeling of the node uses the resultant appearance-modeling data via a cross-attention layer of the graph transformer network

7. The method of claim 1, wherein the motion modeling yields resultant motion-modeling data.

8. The method of claim 1, comprising post-processing the resultant motion-modeling data via motion propagation and node merging.

9. The method of claim 8, wherein the post-processing comprises adding a node to the graph via link prediction.

10. The method of claim 8, wherein the post-processing comprises removing a node from the graph via link prediction.

11. A system for three-dimensional object tracking across cameras, comprising:
memory; and
at least one processor coupled to the memory and configured to implement a method, the method comprising:
receiving detection outcomes generated by a three-dimensional object detector from a plurality of synchronized camera inputs;
responsive to the receiving, maintaining a graph comprising nodes and weighted edges between at least a portion of the nodes;
executing appearance modeling of the nodes via a self-attention layer of a graph transformer network; and
executing motion modeling of the nodes.

12. The system of claim 11, wherein the nodes represent tracked objects comprising at least one of appearance features or motion features.

13. The system of claim 11, wherein the weighted edges are computed based at least in part on node similarity.

14. The system of claim 13, wherein the node similarity is computed based on at least one of appearance similarity or location similarity between the tracked objects.

15. The system of claim 11, wherein the appearance modeling yields resultant appearance-modeling data.

16. The system of claim 15, wherein the executing the motion modeling of the node uses the resultant appearance-modeling data via a cross-attention layer of the graph transformer network

17. The system of claim 11, wherein the motion modeling yields resultant motion-modeling data.

18. The system of claim 11, comprising post-processing the resultant motion-modeling data via motion propagation and node merging.

19. The system of claim 18, wherein the post-processing comprises at least one of adding a node to the graph or removing a node from the graph via link prediction.

20. A computer program product comprising a non-transitory computer-usable medium having computer-readable program code embodied therein, the computer-readable program code adapted to be executed to implement a method for three-dimensional object tracking across cameras, comprising:
receiving detection outcomes generated by a three-dimensional object detector from a plurality of synchronized camera inputs;
responsive to the receiving, maintaining a graph comprising nodes and weighted edges between at least a portion of the nodes, wherein the nodes represent tracked objects and comprise appearance features and motion features, and wherein the weighted edges are computed based on node similarity;
executing appearance modeling of the nodes via a self-attention layer of a graph transformer network, wherein the appearance modeling yields resultant appearance-modeling data; and
executing motion modeling of the nodes using the resultant appearance-modeling data via a cross-attention layer of the graph transformer network. wherein the motion modeling yields resultant motion-modeling data.
